(19) United States
(12) Patent Application Publication
(10) Pub. No.: US 2016/0325239 A1
(43) Pub. Date: Nov. 10, 2016

(54) COMPOSITE POLYAMIDE MEMBRANE INCLUDING CELLULOSE-BASED QUATERNARY AMMONIUM COATING

(71) Applicant: Dow Global Technologies LLC, Midland, MI (US)

(72) Inventors: Roland ADDEN, Bomlitz (DE); Tina L. ARROWOOD, Elko New Market, MN (US); Patrick S. HANLEY, Midland, MI (US); Hao JU, Woodbury, MN (US); Ian A. TOMLINSON, Midland, MI (US)

(21) Appl. No.: 15/109,677

(22) PCT Filed: Jan. 26, 2015
(86) PCT No.: PCT/US2015/012812

§ 371 Date: Jul. 5, 2016

Related U.S. Application Data
(60) Provisional application No. 61/933,906, filed on Jan. 31, 2014.

(51) Int. Cl. B01D 71/56; B01D 65/08; B01D 61/02; B01D 71/10; B01D 71/12; B01D 69/12; B01D 67/00

(52) U.S. Cl. CPC B01D 71/56; B01D 69/125; B01D 65/08; B01D 67/0088; B01D 71/10; B01D 71/12; B01D 61/02; B01D 2323/40; B01D 2325/16

(57) ABSTRACT

thin film composite membrane comprising a thin film polyamide layer located between a porous support and a coating layer, wherein the coating layer comprises a cellulose-based polymer including a plurality of quaternary ammonium groups or salts thereof.

### FIELD

The present invention is directed toward polyamide composite membranes.

### INTRODUCTION

Composite membranes are used in a variety of fluid separations. One type are “thin film composite” (TFC) membranes which include a thin film discriminating layer provided upon an underlying porous support. The thin film layer may be formed by an interfacial polycondensation reaction between polyfunctional amine (e.g. m-phenylenediamine) and polyfunctional acyl halide (e.g. trimesoyl chloride) monomers which are sequentially coated upon the support from immiscible solutions. Examples are described in U.S. Pat. No. 4,277,344 and U.S. Pat. No. 6,878,278.

Polymer coatings can be applied to modify the surface properties of the membrane, e.g. to improve fouling resistance. Examples are described in: U.S. Pat. No. 8,025,159 (ionic macromolecules including polystyrene, polyvinylamidine, polyvinylpyridine, polypyrrol and polyvinyldiazole that include quaternary ammonium groups), U.S. Pat. No. 6,177,011 and U.S. Pat. No. 8,443,986 (polyvinyl alcohol), U.S.2010/0133172 (cellulosics, polyvinyl alcohol, polyacrylates, polyethylene oxides), U.S. Pat. No. 8,017,050 (polydopamine), U.S. Pat. No. 8,002,120 (polyoxazoline), and U.S. Pat. No. 6,280,853, U.S. Pat. No. 6,913,694, U.S. Pat. No. 7,918,349, U.S. Pat. No. 7,905,361, U.S. Pat. No. 7,815,987, U.S.2011/0220569, U.S.2011/0259817, U.S.2011/0284454, U.S.2011/0284454 (polyalkylene oxide, blends and derivatives). R. Malaisamy et al., Polyelectrolyte Modification of Nanofiltration Membranes for Selective Removal of Monovalent Anions, Separation and Purification Technology 77, 367-374 (2011) describes a multi-layer coating including alternating polyelectrolyte thin films including polystyrene sulfonate and poly(diallyl dimethyl ammonium) chloride. See also T. Ishigami, et al., Fouling Reduction of Reverse Osmosis Membrane by Surface Modification via Layer-by-Layer Assembly, Separation and Purification Technology 99, 1-7 (2012), and S. Liu, et al., The Effect of Polymer Surface Modification via Interfacial Polymerization on Polymer-Protein Interaction, (2009) www.interscience.wiley.com. S. Belfer et al., Journal of Membrane Science, volume 139, no. 2, 175-181 (1998) describes a method for inhibiting membrane fouling by radically grafting methacrylic acid or polyethylene glycol methacrylate directly on the polyamide surface of composite membranes. See also U.S. Pat. No. 7,677,398. The search continues for durable coatings that provide fouling resistance with minimal reduction in flux.

### SUMMARY

The invention includes a thin film composite membrane including a thin film polyamide layer located between a porous support and a coating layer, wherein the coating layer includes a cellulose-based polymer including a plurality of quaternary ammonium groups.

### BRIEF DESCRIPTION OF THE DRAWINGS

FIG. 1 is a plot of operating flux (GFD) vs. flux loss (GFD) using a silicate fouling test as described in the Example section.

FIG. 2 is a plot of operating flux (GFD) vs. flux loss (GFD) using an alumina fouling test as described in the Example section.

### DETAILED DESCRIPTION

The invention is not particularly limited to a specific type, construction or shape of composite membrane or application. For example, the present invention is applicable to flat sheet, tubular and hollow fiber polyamide membranes useful in a variety of applications including forward osmosis (FO), reverse osmosis (RO), nano filtration (NF), ultra filtration (UF), micro filtration (MF) and pressure retarded fluid separations. However, the invention is particularly useful for membranes designed for RO and NF separations, collectively referred to as “hyperfiltration.” RO composite membranes are relatively impermeable to virtually all dissolved salts and typically reject more than about 95% of salts having monovalent ions such as sodium chloride. RO composite membranes also typically reject more than about 95% of inorganic compounds as well as organic molecules with molecular weights greater than approximately 100 Daltons. NF composite membranes are more permeable than RO composite membranes and typically reject less than about 95% of salts having monovalent ions while rejecting more than about 50% (and often more than 90%) of salts having divalent ions—depending upon the species of divalent ion. NF composite membranes also typically reject particles in the nanometer range as well as organic molecules having molecular weights greater than approximately 200 to 500 Daltons.

Examples of composite polyamide membranes include FilmTec Corporation FT-30TH type membranes, i.e. a flat sheet composite membrane comprising a bottom layer (back side) of a nonwoven backing web (e.g. PET scrim), a middle layer of a porous support having a typical thickness of about 25-125 μm and top layer (front side) comprising a thin film polyamide layer having a thickness typically less than about 1 micron, e.g. from 0.01 micron to 1 micron but more commonly from about 0.01 to 0.1 μm. The porous support is typically a polymeric material having pore sizes which are of sufficient size to permit essentially unrestricted passage of permeate but not large enough so as to interfere with the bridging over of a thin film polyamide layer formed thereon. For example, the pore size of the support preferably ranges from about 0.001 to 0.5 μm. Non-limiting examples of porous supports include those made of: polysulfone, polyether sulfone, polyimide, polyamide, polyetherimide, polyacrylonitrile, poly(methyl methacrylate), polyethylene, polypropylene, and various halogenated polymers such as polyvinylidene fluoride. For hyperfiltration applications, the porous support provides strength but offers little resistance to fluid flow due to its relatively high porosity.

Due to its relative thinness, the polyamide layer is often described in terms of its coating coverage or loading upon the porous support, e.g. from about 2 to 5000 mg of polyamide per square meter surface area of porous support and more preferably from about 50 to 500 mg/m². The polyamide layer is preferably prepared by an interfacial polycondensation reaction between a polyfunctional amine monomer (e.g. m-phenylenediamine (mPD)) and a polyfunctional acyl halide monomer (trimesoyl chloride (TMC)) upon the surface of the porous support as described in U.S. Pat. No. 4,277,344 and U.S. Pat. No. 6,878,278. More specifically, the polyamide membrane layer may be prepared by interfacial polymerization of a polyfunctional amine monomer with a polyfunctional acyl halide monomer, (wherein each term is intended to refer both to the use of a single species or multiple species), on at least one surface of a porous support. As used herein, the term “polyamide” refers to a polymer in which amide linkages (—C(O)NH—) occur along the molecular chain. The polyfunctional amine and polyfunctional acyl halide monomers are most commonly applied to the porous support by way of a coating step from solution, wherein the polyfunctional amine monomer is typically coated from an aqueous-based or polar solution and the polyfunctional acyl halide from an organic-based or non-polar solution. Although the coating steps need not follow a specific order, the polyfunctional amine monomer is preferably first coated on the porous support followed by the polyfunctional acyl halide. Coating can be accomplished by spraying, film coating, rolling, or through the use of a dip tank among other coating techniques. Excess solution may be removed from the support by air knife, dryers, ovens and the like.

The polyfunctional amine monomer may be applied to the porous support as a polar solution. The polar solution may contain from about 0.1 to about 10 wt % and more preferably from about 1 to about 6 wt % polyfunctional amine monomer. In one set of embodiments, the polar solutions includes at least 2.5 wt % (e.g. 2.5 to 6 wt %) of the polyfunctional amine monomer. Once coated on the porous support, excess solution may be optionally removed.

The polyfunctional acyl halide may be dissolved in a non-polar solvent in a range from about 0.01 to 10 wt %, preferably 0.05 to 3% wt % and may be delivered as part of a continuous coating operation. In one set of embodiments wherein the polyfunctional amine monomer concentration is less than 3 wt %, the polyfunctional acyl halide is less than 0.3 wt %. Representative examples include suitable non-polar solvents include paraffins (e.g. hexane, cyclohexane, heptane, octane, dodecane) and isoparaffins (e.g. ISOPAR™ L). The non-polar solution may include additional constituents including co-solvents, phase transfer agents, solubilizing agents, complexing agents and acid scavengers wherein individual additives may serve multiple functions. Representative co-solvents include: benzene, toluene, xylene, mesitylene, ethyl benzene diethylene glycol dimethyl ether, cyclohexanone, ethyl acetate, butyl carbitol™ acetate, methyl laurate and acetone. A representative acid scavenger includes N,N-diisopropylethylamine (DIEA). The non-polar solution may also include small quantities of water or other polar additives but preferably at a concentration below their solubility limit in the non-polar solution.

Once brought into contact with one another, the polyfunctional acyl halide and polyfunctional amine monomers react at their surface interface to form a polyamide layer or film. This layer, often referred to as a polyamide “discriminating layer” or “thin film layer,” provides the composite membrane with its principal means for separating solute (e.g. salts) from solvent (e.g. aqueous feed). The reaction time of the polyfunctional acyl halide and the polyfunctional amine monomer may be less than one second but contact times typically range from about 1 to 60 seconds. Excess solvent can be removed by air blowing or rinsing the membrane with water and followed by drying at elevated temperatures, e.g. from about 40° C. to about 120° C.

The composite membrane further includes a coating layer located upon the thin film polyamide layer (opposite the porous support). In one embodiment, the coating layer is applied to the polyamide layer from a solution that includes a cellulose-based polymer including a plurality of quaternary ammonium groups. The application of the coating solution may be part of a continuous membrane manufacturing process implemented just after formation of the polyamide composite membrane; or may be applied well after the composite membrane is produced, such as in an element (e.g. wherein the cellulose-based polymer is added to pressurized feed water to form a coating solution which is passed through a finished element during operation). The term “applying” or “applied” is intended to broadly describe a wide variety of means of bringing the cellulose-based polymer into contact with at least a surface portion of the polyamide membrane such as by way of spraying, air knifing, rolling, sponging, coating, dipping, brushing or any other known means. One preferred application technique is to apply a thin coating of the modifier over at least a portion of the outer surface of the polyamide membrane by way of a roll contact coater, sometimes referred to in the art as a “kiss” coater. The cellulose-based polymer is preferably delivered from an aqueous-based solution. The solution comprises at least 0.001, preferably at least 0.01, and more preferably at least 0.1 weight percent of the cellulose-based polymer, and less than about 10 and more preferably less than about 1 weight percent of the cellulose-based polymer. The coating solution may also include other constituents including but not limited to co-solvents and modifiers along with residual “carry over” from previous manufacturing steps. The cellulose coating preferably covers a substantial majority of the polyamide surface. The coating layer is preferably provided at a coverage of at least 10 mg/m² (e.g. preferably from 5 mg/m² to 50 mg/m²). This coverage approximately equates to a preferred thickness of from 0.003 μm to 0.03 μm

The coating layer includes a cellulose-based polymer functionalized with a plurality of quaternary ammonium groups or salts thereof. The cellulose-based polymer is not particularly limited and is represented by Formula 1,

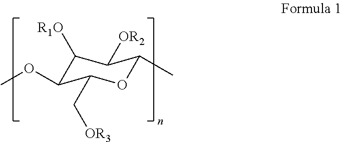

wherein R₁, R₂ and R₃ are independently selected from: hydrogen, hydroxyalkyl, alkyl and alkoxy; wherein hydroxyalkyl, alkyoxy and alkyl groups may comprise from 1 to 130 carbon atoms (preferably 1 to 6 carbon atoms) which may be unsubstituted or substituted with hydroxyl, carboxylic acid, halogen, alkyoxy, hydroxyalkyl and alkyl (wherein hydroxyalkyl, alkyoxy and alkyl groups may comprise from 1 to 30 carbon atoms). Representative examples of suitable cellulose-based polymers include cellulose along with ester and ether derivatives such as: cellulose acetate, cellulose triacetate, cellulose propionate, cellulose acetate propionate, cellulose acetate butyrate, cellulose sulfate, methylcellulose (MC), ethylcellulose (EC), ethyl methyl cellulose, hydroxyethyl cellulose (HEC), hydroxypropyl cellulose (HPC), hydroxyethyl methyl cellulose (HEMC), hydroxypropyl methyl cellulose (HPMC) and carboxymethyl cellulose (CMC). HEC is a preferred cellulose-based polymer. At least a portion of the cellulose repeating units are functionalized such that at least one of R₁, R₂ and R₃ are independently selected from a quaternary ammonium functional group represented by Formula 2.

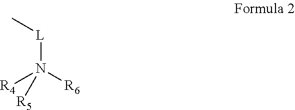

wherein R₄, R₅ and R₆ are independently selected from alkyl and aryl groups (preferably alkyl groups having 1 to 12 carbons) which may be unsubstituted or substituted with alkyl, alkoxy, hydroxyl and halo groups and L is a linking group selected from an alkyl, alkoxy, polyalkoxy or aryl group which may be unsubstituted, or substituted with at least one of: hydroxyl, alkyl, alkyoxy, halo and carboxylic acid. A preferred linking group includes an alkoxy group comprising from 2 to 12 carbon atoms, at least one ether group, and which may be unsubstituted or substituted with one or more hydroxyl groups.

Cellulose-based polymers having relatively higher quaternary ammonium substitution are more strongly electro-statically bound to the thin film polyamide layer and remain on the polyamide layer after prolonged use. Moreover, higher quaternary ammonium substitution imparts a more positive charge to the membrane and reduces fouling of many foulants including silica and alumina. In a preferred embodiment, the cellulose-based polymer has a degree of quaternary ammonium substitution (DS) of from 0.05 to 1, 0.1 to 0.7, and more preferably 0.2 to 0.6; wherein the DS value is the average number of quaternary ammonium groups that are attached to a glucose unit (maximum degree of substitution=3). Some glucose repeat units may have more than one while others may not be substituted. Preferred cellulose-based polymers have a Mw of from 1,000 to 1,000,000, and more preferably form 10,000 to 750,000. Specific examples of preferred coating materials include UCARE™ polymers (INCI name: Polyquaternium-10) such as UCARE™ JR400, SoftCat™ polymers (INCI name: Polyquaternium-67) such as SoftCat™ SK and SX, and CELLOSIZE™ polymers all commercially available from Amerchol Corporation.

### EXAMPLES

Sample thin film composite membranes were prepared as follows. Polysulfone supports were casts in dimethylformamide (DMF) and subsequently soaked in a 3.1 wt % aqueous solution meta-phenylene diamine (mPD). The resulting support was then pulled through a reaction table at constant speed while a thin, uniform layer of a non-polar coating solution was applied. The non-polar coating solution included an isoparaffinic solvent (ISOPAR L), 0.2 wt % trimesoyl acid chloride (TMC), 0.03 wt % 1-carboxy-3,5-dichloroformyl benzene and 0.22 wt % tributyl phosphate. Excess non-polar solution was removed and the resulting composite membrane was sequentially passed through a water rinse tank and drying oven and was then coated (16 mg/m²) with one of the following cellulose materials except for a control:
♦ Control—uncoated
▪ Sodium carboxymethyl cellulose (CMC, WALOCEL™ CRT30 PA, Dow Wolff Cellulosics),
* Hydroxylethyl cellulose (HEC, CELLOSIZE® HEC QP-300, Amerchol Corp.), and
▴ UCARE JR400 (quaternary ammonium degree of substitution=0.4, Amerchol Corp.).

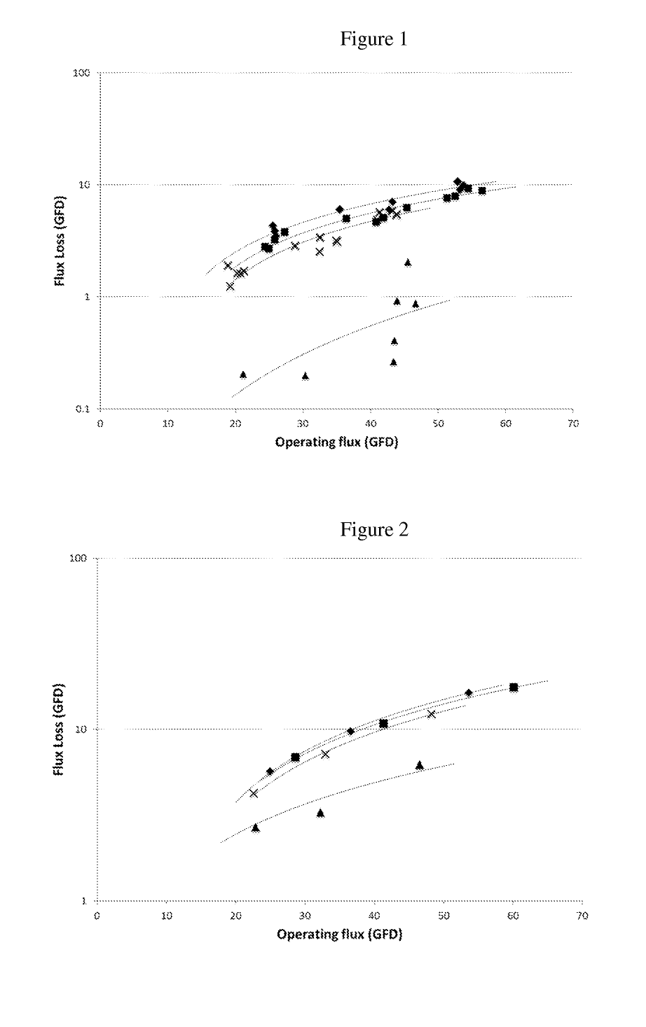

The coated membrane samples were tested as follows. Sample membranes were placed in a flatcell apparatus and allowed to stabilize while being fed with pure RO water at 70 psi and 25° C. for at least 30 minutes, after which the flux of the membranes were measured. The feed pressure was increased to 120 psi and allowed to stabilize for 30 minutes before the flux was re-measured. The feed pressure was increased further to 150 psi and allowed to stabilize before re-measuring the flux. These flux values represent the operating flux and are recorded as gallons per foot square of membrane per day (GFD). After these measurements, water containing the desired amounts of foulants was added to the pure water feed to provide a 20 liter fouling feed water solution, (see the fouling water preparation below). This water was fed to the flatcell apparatus and the system was allowed to stabilize/foul for 60 minutes at 70 psi and 25° C. after which time the flux of the membrane was measured. Then, the pressure was increased to 120 psi and after 60 minute stabilization the flux was re-measured. This was repeated again at 150 psi. For each respective experimental pressure (70, 120, 150 psi) the fouling water flux measurement was subtracted from the pure water flux measurement to provide a “change in flux” value. The data is compared by plotting the “change in flux” vs. the operating flux and is illustrated in FIGS. 1 (silicate fouling water) and 2 (alumina fouling water).

Silicate fouling feed water preparation: The silicate dispersion was prepared by adding 75 mg of polyvinyl alcohol (MW=6,000 g/mol, 80% hydrolyzed, Polysciences, Inc.) and 2 g of silica (silicon dioxide nano powder, spherical and porous, 5-15 nm, Sigma-Aldrich) into 200 ml of water in a conical beaker, pH of which was adjusted to between 8 and 9. The silica dispersion was sonicated for 45 minutes. After the sonication, the dispersion was continuously stirred using a magnetic stir bar until the entire contents was added to the flatcell feed water tank and diluted with RO water to make a final 20 L volume.

Alumina fouling feed water preparation: The aluminum oxide dispersion was prepared by adding 75 mg of polyvinyl alcohol (MW=6,000 g/mol, 80% hydrolyzed, Polysciences, Inc.) and 2 g of aluminum oxide nanoparticle (50 nm, Skyspring Nanomaterials, Inc.) into 200 ml of water in a conical beaker. The pH of which was adjusted to between 8 and 9. The silica dispersion was sonicated for 45 minutes. After the sonication, the dispersion was continuously stirred using a magnetic stir bar until the entire contents was added to the flatcell feed water tank and diluted with RO water to make a final 20 L volume.

1. A thin film composite membrane comprising a thin film polyamide layer located between a porous support and a coating layer, wherein the coating layer comprises a cellulose-based polymer including a plurality of quaternary ammonium groups or salts thereof.

2. The membrane of claim 1 wherein the cellulose-based polymer has a degree of quaternary ammonium substitution (DS) of from 0.05 to 1.

3. The membrane of claim 1 wherein the coating layer has a coverage of at least 10 mg/m².

4. The membrane of claim 1 wherein the thin film polyamide layer comprises a reaction product of a polyfunctional amine monomer and a polyfunctional acyl halide monomer.
